(19) United States
(12) Patent Application Publication
(10) Pub. No.: US 2009/0074994 A1
(43) Pub. Date: Mar. 19, 2009

(54) Kit for Decorating A Car

(76) Inventor: Linda L. McLean, Redding, CA (US)

Correspondence Address: ADVANTIA LAW GROUP, 9035 SOUTH 1300 EAST, SUITE 200, SANDY, UT, 84094, US

(21) Appl. No.: 11/855,301

(22) Filed: Sep. 14, 2007

(51) Int. Cl. B60R 13/00

(52) U.S. Cl. 428/31

(57) ABSTRACT

A kit for decorating a car. There is: a color-changing film, removably coupleable to a surface of a vehicle, and configured to change color based on sun exposure; an adhesive, disposed substantially along an underside of the film, and configured to adhere the film to the surface of the vehicle; and a stencil, configured to stencil shapes to cut out of the color-changing film. There is a cutting device, configured to cut-out shapes from the color-changing film. The color-changing film has a pre-cut shape. The adhesive is a pressure sensitive adhesive.

### BACKGROUND OF THE INVENTION

1. Field of the Invention

The present invention relates to decorating vehicles, specifically kits for decorating cars with color-changing film and stencils.

2. Description of the Related Art

In the related art, it has been known to use photochromic materials to affect the visual appearance of an object and/or affect the intensity of light that is permitted to pass through such objects. Many objects such as buildings, houses, and cars are painted or coated with certain materials that provide for aesthetically pleasing appearance when shone upon by the sun. Many people seek to create dazzling color effects with there possessions to capture the attention of others, most especially with cars. There is a need for a means to provide for color effects that will continually capture the attention of others through uniqueness and color changing effects. Some improvements have been made in the field. Examples include but are not limited to the references described below, which references are incorporated by reference herein:

U.S. Pat. No. 4,444,939 issued to Postle et al., discloses a photochromic paint comprising a latex of an acrylate and/or a methacrylate polymer, the polymer particles of which constitutes 30 to 50% by weight of the latex and which has been prepared using a copolymerizable surfactant, there being dispersed in the latex photochromic glass beads of from 0.05 to 1.00 mu.m in size and which comprises from 10 to 30% by weight of the latex, the total solids content of the latex being from 40 to 60% by weight.

U.S. Pat. No. 4,012,232, issued to Uhlmann et al., discloses an organic photochromic materials comprise a photochromic pigment stabilized with a protective inorganic coating which serves to protect the pigments from deactivation by exposure to moisture, oxygen, various plastic host materials, reactive chemicals or even normal atmospheric conditions. Useful organic photochromic pigments include the anils, hydrazones, semicarbozones, osazones, sydnones, fulgides and others. Inorganic coatings comprising such materials as zinc oxide, titanium dioxide, aluminum oxide, antimony oxide and silicon dioxide are useful in the preparation of photochromic plastic films, sheets, ophthalmic lenses such as lenses for sunglasses and in camera lenses and filters.

U.S. Pat. No. 5,976,717, issued to Holdik et al., discloses a coating comprising a photochromic material, its production and its use. The photochromic material of the coating has an optically reversible photochromic effect, wherein the switching threshold is disposed outside of or in the boundary region of the visible range of the spectrum. According to the invention, the photochromic material is coated with an influencing material, so that the switching threshold of the coated photochromic material is shifted towards wavelengths longer than the switching threshold of the uncoated photochromic material.

U.S. Pat. No. 5,603,757, issued to Mizuguchi et al., discloses a photochromic brightening pigment comprises a brightening pigment and a photochromic material which is encapsulated so as to adhere it to the surface of the brightening pigment.

U.S. Pat. No. 3,744,295, issued to Allinikov, discloses a photochromic-thermochromic coating composition is provided that comprises a resin base paint, a dye and an enzyme. The coating composition is sensitive to light and heat.

U.S. Pat. No. 5,604,626, issued to Teowee et al., discloses a photochromic device is provided which allows the user to leave the device in a high transmissive state even when exposed to a source of radiation and to control the degree of darkening achieved while exposed to the source of radiation.

The inventions heretofore known suffer from a number of disadvantages which include being limited in use, limited appeal, complex, unsuitable, expensive and/or otherwise fails to be unique, convenient and/or effective as a solar affected color coating.

What is needed is a kit for decorating a car that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available photochromic materials. Accordingly, the present invention has been developed to provide a kit for decorating a car having a color-changing film and a stencil.

In one embodiment, there may be a kit for decorating a car, including: a color-changing film, removably coupleable to a surface of a vehicle, and/or configured to change color based on sun exposure; an adhesive, disposed substantially along an underside of the film, and/or configured to adhere the film to the surface of the vehicle; and/or a stencil, configured to stencil shapes to cut out of the color-changing film.

In another embodiment, there may be a cutting device, configured to cut-out shapes from the color-changing film.

In still another embodiment, the color-changing film may have a pre-cut shape.

In yet another embodiment, the adhesive may be a pressure sensitive adhesive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front perspective view of a car decorated with a kit for decorating a car, according to one embodiment of the invention;

FIG. 2 is a front view of a stencil, according to one embodiment of the invention; and

FIG. 3 is a cross-sectional side view of a car decorated with color-changing film, according to one embodiment of the invention.

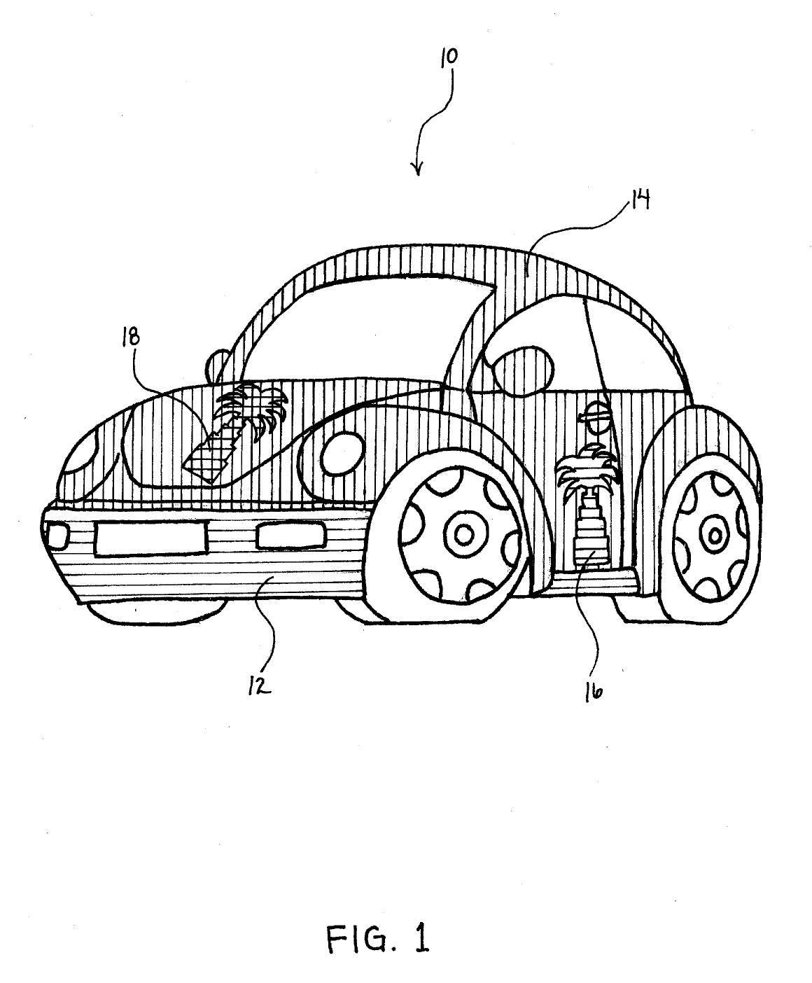

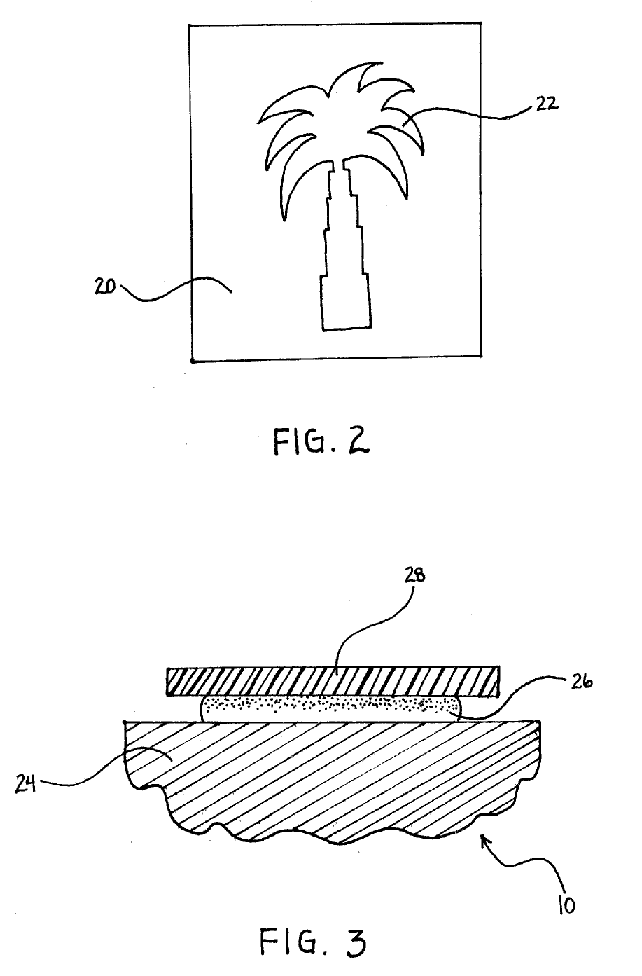

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Looking to the figures, there is shown a car 10 decorated with a kit for decorating a car. The kit includes color-changing film 18 and a stencil 20. As shown, there is a red color-changing film 18, which is removably coupled to a blue exterior 12 of the car 10. The red color-changing film 14 has a cut-out 16 of a palm tree created by a stencil, and the blue exterior 12 is shown in place of the cut-out 16. There is also a yellow color-changing film 18 removably coupled to a surface of the red color-changing film 14. The yellow color-changing film 18, has been cut into its shape by using the stencil. The color-changing film 14, 18 may be as Example 7 of Patent Application Publication No. 2006/0054838 by Ribi et al., incorporated by reference herein.

The illustrated stencil 20, includes a cut-out shape 22 for reproduction. In operation, the cut-out shape 22 may be traced onto the color-changing film 14, 18. Then traced shape may be cut-out of the color-changing film 14, 18 by a cutting device, such as scissors, or a knife. The color-changing film 14, 18 may then be placed on the exterior 12 of a car 10. The traced shape may also be placed on an exterior 12 of a car 10, or on color-changing film 14, 18. As illustrated, the cut-out shape 22 is a palm tree.

In addition, a cross-sectional view of a car 10 decorated with color-changing film 24 showing layering is illustrated. There is color-changing film 24 removably coupled to a surface 24 of a car 10 by an adhesive 26. The adhesive 26 may be electrostatic attraction between the color-changing film 24 and the surface 24.

In operation, the stencil 20 is used to define a shape 22 for cutting from the color-changing film 14. The color-changing film 14 with the cut-out 16 is removably coupled to the car 10 by an adhesive 26. In addition, the stencil 20 may be used to cut out the shape 22 from the color-changing film 18, which may be removably coupled to the car 10 or the color-changing film 14 by an adhesive. The color-changing film 14, 18, 28 changes the color of the car 10 based on sun exposure.

For example, when the car 10 is in the shade, the color-changing film 14, 18 may be red and yellow, respectively. However, when the car 10 is in the sun, the color-changing film 14, 18 may change to green and purple, respectively, based on sun exposure.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although a car 10 is shown, the color-changing film 14, 18, 24 could be applied to a variety of vehicles, such as, but not limited to: trucks, bicycles, motorcycles, boats, all terrain vehicles, and airplanes. In addition, the color-changing film 14, 18, 24 may be pre-cut to fit directly over the desired vehicle. Further, the color-changing film 14, 18, 24 may be applied to other surfaces known in the art. Some non-limiting examples of such surfaces include those of: windows, doors, walls, and color-changing film 14, 18, 24.

Additionally, although the figures illustrate red color-changing film 14 and yellow color-changing film 18, the color-changing film 14, 18, 24 may be any color known in the art, such as, but not limited to: purple, blue, green, orange, pink, silver, gold, brown, black, white, etc. and combinations thereof. Similarly, the color-changing film 14, 18, 24 may change from one color to any other color known in the art. The color-changing film 14, 18, 24 may also be multicolored and/or patterned. Some non-limiting examples of patterns include: stripes, plaids, and polka dots, and combinations thereof. Further, the color-changing film 14, 18, 24 may have a colorless mode based on sun exposure. Lastly, the color-changing film 14, 18, 24 may be transparent.

It is also envisioned that a photochromic paint could be used for decorating in addition to, or instead of, the color-changing film 14, 18, 24. Similarly, any other covering known in the art could be used. Some non-limiting examples of other coverings known in the art include stickers and decals. Accordingly, the kit for decorating a car 10 may include other coverings known in the art such as photochromic paint, stickers, and/or decals instead of, or in addition to the color-changing film 14, 18, 24.

In addition the means for applying color-changing film to the surface of the vehicle includes: electrostatic attraction; an adhesive; and/or a photochromic paint. The electrostatic attraction may be between the color-changing film and the surface of the vehicle, or between the color-changing film and another color-changing film. The adhesive may include a pressure sensitive adhesive, such as glue or tape.

Further, although the figures illustrate a color-changing film 14, 18 with a cut-out 16 which covers a majority of the exterior 12 of the car 10, the kit for decorating a car 10 could be used to apply small cut-outs of traced shapes instead of, or in addition to, the color-changing film 14, 18. In addition, the small cut-outs of traced shapes could be positioned to overlap other small cut-outs or a large color-changing film 14, 18. Also, the small cut-outs of traced shapes could have a variety of shapes and colors.

It is expected that there could be numerous variations of the design of this invention. An example is that the stencil 20 could have a plethora of shapes. Some examples of such shapes include, but are not limited to: astrological signs, characters, letters, logos, flowers, flames, stripes, skulls, stars, hearts, moons, vines, lips, cacti, mushrooms, animals, bugs, cowboy hats, and sporting goods. Another example that the color-changing film 14, 18, 24 could be peeled off and moved to various locations as desired.

Finally, it is envisioned that the components of the kit for decorating a car may be constructed of a variety of materials. The color-changing film 14, 18, 24 may be composed of any polymeric material known in the art, such as plastic, or any coating known in the art, such as a photochromic paint, for example. The adhesive 26 may be the electrostatic attraction between the color-changing film 14, 18, 24 and the car 10, or the adhesive 26 may be composed a pressure sensitive adhesive, such as glue or tape, for example. The stencil 20 may be composed of any material known in the art such as metal, wood, plastic, etc. and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A kit for decorating a car, comprising:
a) a color-changing film, removably coupleable to a surface of a vehicle, and configured to change color based on sun exposure;
b) an adhesive, disposed substantially along an underside of the film, and configured to adhere the film to the surface of the vehicle; and
c) a stencil, configured to stencil shapes to cut out of the color-changing film.

2. The kit of claim 1, further comprising a cutting device, configured to cut-out shapes from the color-changing film.

3. The kit of claim 2, wherein the color-changing film has a pre-cut shape.

4. The kit of claim 3, wherein the adhesive is a pressure sensitive adhesive.

5. A kit for decorating the exterior of a car, consisting essentially of:
a) a color-changing film, removably coupleable to a surface of a vehicle, and configured to change color based on sun exposure;
b) a means for applying the color-changing film to the surface of the vehicle;
c) a stencil, configured to stencil shapes to cut out of the color-changing film; and
d) a cutting device, configured to cut-out shapes from the color-changing film.

6. The kit of claim 5, wherein the color-changing film has a pre-cut shape.
